(19) United States
(12) Patent Application Publication
(10) Pub. No.: US 2023/0161319 A1
(43) Pub. Date: May 25, 2023

(54) COMPUTER-IMPLEMENTED METHOD FOR RECOGNIZING AN INPUT PATTERN IN AT LEAST ONE TIME SERIES OF A PLURALITY OF TIME SERIES

(71) Applicants: Siemens Aktiengesellschaft, Munchen (DE); Siemens AG Österreich, Wien (AT)

(72) Inventors: Joachim Fröhlich, Kirchseeon (DE); Stefan Rothbauer, Augsburg (DE); Tudor Ionescu, Wien (AT)

(21) Appl. No.: 17/987,258

(22) Filed: Nov. 15, 2022

(30) Foreign Application Priority Data
Nov. 19, 2021 (EP) 21209337.1

(51) Int. Cl. G05B 19/406

(52) U.S. Cl. CPC G05B 19/406; G05B 2219/50193

(57) ABSTRACT

A method for recognizing an input pattern in at least one time series is provided including a. providing the time series; b. generating associated time series sections of a specific length on the basis of the time series by a combination of statistical approaches or a machine learning model; c. indexing each time series section; d. assigning each time series section to an applicable key value index; e. recognizing the input pattern in at least one time series of the plurality of time series by identifying at least one time series section that matches or is similar to the input pattern by a similarity search approach on the basis of the plurality of indexed time series sections; and f. providing the at least one identified time series section as an output pattern that matches or is similar to the input pattern if a match or similarity is detected.

### CROSS-REFERENCE TO RELATED APPLICATIONS

This application claims priority to EP Application No. 21209337.1, having a filing date of Nov. 19, 2021, the entire contents of which are hereby incorporated by reference.

### FIELD OF TECHNOLOGY

The following relates to a computer-implemented method for recognizing an input pattern in at least one time series of a plurality of time series. The following also relates to a corresponding technical system and computer program product.

### BACKGROUND

Pattern recognition or event detection with respect to technical systems is becoming increasingly important with advancing digitization. Reliable pattern recognition or event detection, in particular detection of critical or safety-critical events, allows hazards and damage to be at least reduced or completely prevented. Furthermore, damage that has already occurred may also be minimized.

By way of example, such hazards or damage arise from an interaction between human beings and a technical system, such as a technical system in the field of machine learning (“machine learning system”), of an industrial installation or of a robot unit. The number of interactions and the complexity thereof increase with advancing digitization.

According to the conventional art, the pattern recognition or event detection comprises looking for an input pattern in time series. This is usually accomplished by comparing an input pattern with every time series of a plurality of time series. Usually, not just exact matches but also similar matches are sought. The disadvantage of this, however, is that this search is very complex and computation-intensive.

In most cases, the search is also carried out on the basis of large volumes of data, and therefore a large number of time series. This also substantially increases the complexity and the time involvement.

Embodiments of the present invention are therefore based on the objective technical problem of providing a computer-implemented method for recognizing an input pattern in at least one time series of a plurality of time series that is more reliable and more efficient.

### SUMMARY

An aspect relates to a computer-implemented method for recognizing an input pattern in at least one time series of a plurality of time series; wherein the input pattern is a time series section of a specific length; having the steps of

a. providing the plurality of time series; wherein each time series of the plurality of time series comprises a chronologically ordered sequence of input data;

b. generating a plurality of associated time series sections of a specific length on the basis of the plurality of time series by a combination of statistical approaches or a machine learning model; wherein

the machine learning model was trained on at least some of the plurality of time series using the combination of statistical approaches;

c. indexing each time series section of the plurality of time series sections;

d. assigning each time series section to an applicable key value index; wherein the respective key value index comprises a numerical vector that denotes the respective time series section as a key and the at least one position or the at least one place in the respective time series as a value;

e. recognizing the input pattern in at least one time series of the plurality of time series by identifying at least one time series section that matches or is similar to the input pattern by a similarity search approach on the basis of the plurality of indexed time series sections; and

f. providing the at least one identified time series section as an output pattern that matches or is similar to the input pattern if a match or similarity is detected.

Accordingly, embodiments of the invention are directed to a computer-implemented method for recognizing an input pattern in a plurality of time series. The input pattern is a time series section of a specific length, and therefore a section of a time series.

The time series sections may also be referred to as data windows. The time series sections, such as input patterns, may also be in the form of numerical vectors.

The input pattern may have an appropriate length, for example long enough to represent the input pattern and record desired properties. A similar order of magnitude in regard to the length of the generated time series sections from the time series, window length, may also be chosen for the length of the input pattern. Accordingly, as an example, the pattern may have a length of 80-150 when the window length of the other time series sections generated is 100.

In a first step, the time series are provided. The time series comprise input data in a time sequence, for example input data of a specific physical size. The input data may also be in the form of measurement data or in the form of system state data. The measurement data may be different measurement data, measurement data from a technical system, for example depending on the underlying technical system or the application of the pattern recognition, etc.

The technical system may be in the form of a safety-critical system (SCS) or in the form of a critical infrastructure system, which may have one or more system subunits or components. Illustrative SCSs are autonomous vehicles or industrial installations, etc. Illustrative critical infrastructure systems are low-voltage grids or energy delivery systems (for example natural gas pipelines).

In a second step, time series sections are generated from the time series. A sliding window method may be used for this. In other words, an analysis window may be slid over the time series in an analysis window sliding direction. Various parameters, such as window length and time step length, etc., may be taken into consideration at this time. A combination of statistical approaches (KSA) or a machine learning model trained by the KSA is applied to these generated time series sections of a specific length in order to obtain the numerical vectors for the time series sections.

A plurality of statistical output values are initially ascertained, in the form of a numerical vector, for the combination of statistical approaches. The output values are ascertained by using a plurality of different statistical approaches, such as for change-point, anomaly or structural-break detection in time series data or segmentation of time series data that are based on statistical characteristic quantities, random-sample functions or models, such as for example variance, mean value, autocorrelation, autoregression or autoencoders, etc. Therefore, the statistical approaches are inherently different from one another, but at the same time are functionally redundant and therefore also serve the same purpose, event detection. The plurality of statistical approaches are referred to as a combination or as a set, and therefore as a combination of statistical approaches. By way of example, the same function may be used with multiple different parameters. Alternatively, different functions, different source code of a function, different computing methods or different algorithms may be used.

Accordingly, the statistical approaches each result in at least one associated statistical output value. The statistical output value may be in the form of a bit (binary digit). A bit may assume the values “0” or “1”, with “1” indicating that a specific statistical approach from the combination of statistical approaches has detected an event in the time series segment under consideration.

Furthermore, the plurality of statistical output values may be converted or combined into at least one statistical label. The statistical label may be in the form of a bit sequence or binary code. The statistical label may also be referred to as an event class.

The statistical label may comprise the following binary code, for example: 10011. For each statistical approach, a bit is displayed indicating whether the associated statistical approach has (1) or has not (0) detected an event. In the 10011 example, 5 statistical approaches form a combination of statistical approaches, 3 of the 5 approaches detecting an event and 2 of the 5 approaches not detecting an event. The majority of the statistical approaches therefore detect an event.

The statistical label may denote at least one causal factor for the at least one event in regard to the technical system. The statistical label may also denote at least one alarm level for the at least one event in regard to the technical system.

The event as such may also relate to change points, anomalies or other safety-relevant events in the measurement data. A majority rule or a majority principle may provide additional information about the type of event and the reliability (confidence) of the statement by the combination of statistical approaches.

In the case of an event class, the pattern recognition may also be called event detection. In other words, the claimed method may be used to detect an event.

These aforementioned steps may also be referred to as ensemble prediction. Reliability is significantly increased by ensemble prediction and the amount of detected events is significantly reduced.

As an alternative to the combination of statistical approaches, a machine learning model (“trained supervised machine learning model”) trained on time series sections for event detection may be used to detect one or more events in regard to a technical system. The term “machine learning model” may be abbreviated to ML model.

The learning model may be in the form of any model in the field of machine learning, such as neural networks, random forests, support vector machines, etc. The learning model is also used for event detection. The event is related to the technical system or is associated therewith, including its units or its environment.

In further steps, the time series sections are indexed and each time series section is assigned to an applicable key value index. The index is a key value index in this case. The index comprises a numerical vector that denotes the respective time series section as a key and the at least one position or one place in the respective time series as a value. The position or place may be formed by a timestamp or identifier. The key in this case corresponds to a statistical label generated for the respective time series section by a KSA, which label may be a numerical vector.

In a further step, the input pattern is recognized in the plurality of time series by using one or more searches for the same, or identical, input pattern or patterns similar to the input pattern in the indexed time series sections. The search may result in one or more output patterns as output.

Various search methods may be used in this case. By way of example, identical input patterns may initially be recognized and output. Alternatively, or additionally, the search may be directed to similar input patterns and one or more similar output patterns may be output.

The various search methods may also be performed in succession according to one configuration, first a range search as a first search for a first set of search results and then a point search for a second set of search results.

The method according to embodiments of the invention allows efficient and reliable recognition of the input pattern. In contrast to the conventional art, the method may be applied to large volumes of data from time series. The time involvement is also significantly reduced, in contrast to the conventional art, by the indexing of the time series sections. The search for the input pattern on the basis of the indexed time series sections may be chosen flexibly on the basis of the user requirements, the applications, the input data and the underlying technical system.

In one configuration, the input pattern is input by a user via an input interface, by a manual input or a voice input. Accordingly, the input pattern is input by the user via an input interface such as an input mask. The user may input the input pattern in the input mask as text in digital form or by a voice command. Alternatively, the input pattern may be received via one or more other interfaces without user interaction, such as for example the manual selection of a range (time series section) in a time series, which is subsequently referred to as the input pattern. The pattern may be manually input in a file, input using a selection from a larger time series, using copy/paste or using a graphic.

In a further configuration, the plurality of time series and/or the plurality of associated time series sections are stored in a database or cloud. Accordingly, the time series and/or the sections thereof are stored in a volatile or non-volatile storage medium. The database and the cloud have been found to be advantageous in respect of efficient and reliable data storage and data access.

In a further configuration, the input data are acquired by way of a data acquisition unit, a sensor unit, a camera unit or an image recognition unit. Accordingly, the input data are acquired efficiently and reliably by a data acquisition unit. The data acquisition unit may be flexibly selected on the basis of the specific application, the input data and/or the underlying technical system. Different data acquisition units may also be chosen for different input data.

In a further configuration, the plurality of time series are provided via one or more interfaces. Accordingly, the time series are efficiently received as input data by way of one or more input interfaces.

In a further configuration, the indexed time series sections are stored in a database or cloud. Accordingly, there may be provision for different, or separate, storage media for the time series, unindexed, and for the indexed time series. The indexed data are stored in an index storage medium, such as a database or cloud. As an alternative to separating the data into separate discrete storage media, it is also possible to use a common storage medium for all of the time series, unindexed and indexed. The index database may be independently used for different applications, including the search for the input pattern.

In a further configuration, the numerical vector is a statistical label, a cardinal statistical label.

In a further configuration, the similarity search approach is a search method for searching for patterns based on similarity, the approach is based on dynamic time normalization (dynamic time warp, DTW).

In a further configuration, the method additionally has the step of performing at least one measure on the basis of the at least one identified time series section as output pattern, wherein the measure is a measure selected from the group consisting of:
displaying the output pattern on a display unit, the output pattern being displayed to a user;
the user analyzing or processing the output pattern;
selecting or filtering the output pattern from a plurality of the identified time series sections, taking account of the preceding analysis or processing by the user;
transmitting the at least one output pattern to a computing unit for further analysis, further processing, further selection or further filtering by way of the computing unit;
storing the output pattern in a storage unit, the storage unit being a volatile or non-volatile storage medium;
analyzing or processing the output pattern;
selecting or filtering the output pattern from a plurality of the identified time series sections;
initiating a countermeasure on the basis of the analysis, the processing, the selection or the filtering; and
providing an error message if no match or no similarity is detected.

Accordingly, a subsequent measure is performed after the input pattern recognition. By way of example, the recognized input pattern and/or also the at least one associated output pattern are safety-relevant, safety- or infrastructure-critical, for example with respect to an SCS.

One or more measures may be initiated after the input pattern recognition. The measures may be performed simultaneously, in succession or else in stages. As a result, the measures are taken promptly and efficiently.

First of all, in a first step the at least one output pattern may be simply displayed to the user. The user may take the output pattern as a basis for starting a further analysis, for example if the user deems the output pattern to be safety-relevant. The output pattern may be a statistical label in the form of an event class that denotes at least one causal factor or an alarm level for at least one event in regard to the technical system. The output pattern is therefore safety-relevant. As an alternative to the further analysis or following more in-depth analysis, the user may initiate countermeasures in order to avert a hazard. The analysis may be useful for the user in order to decide whether one or more countermeasures are required and need to be initiated. The analysis may also reveal that the event has an effect on human beings and/or machines, such as a technical system or a controller. The effect may be for example maloperation of the technical system or of a unit and may endanger the safety of human beings and/or machines. In this case, a countermeasure may be reliably and efficiently initiated in order to eliminate the hazard. The effect may also be maloperation of a technical system as part of a power supply grid, which maloperation may endanger the power supply.

The countermeasure may relate to shutting down the machine or may require the performance of further analysis steps, etc. Damage to man and/or machine is therefore reliably prevented.

As an alternative to user interaction, the listed and claimed measures may also be performed automatically by way of the computer-implemented method, or the at least one output pattern is transferred to another computing unit.

Embodiments of the invention also relate to a technical system. Accordingly, the method according to embodiments of the invention are performed by way of a technical system. The technical system may have one or more subunits such as computing units. By way of example, one method step or multiple method steps may be performed on one computing unit. Other method steps may be performed on the same or a different computing unit. Additionally, the technical system may also comprise storage units, etc.

Embodiments of the invention also relate to a computer program product (non-transitory computer readable storage medium having instructions, which when executed by a processor, perform actions) having a computer program that comprises means for performing the method described above when the computer program is executed on a program-controlled device.

A computer program product, such as e.g., a computer program means, may be provided or delivered, for example, as a storage medium, such as e.g., a memory card, USB stick, CD-ROM, DVD, or in the form of a downloadable file from a server in a network. This may take place, for example, in a wireless communication network by way of the transmission of an applicable file containing the computer program product or the computer program means. A suitable program-controlled device is in particular a control device, such as for example an industrial control PC or a programmable logic controller, PLC for short, or a microprocessor for a smartcard or the like.

### BRIEF DESCRIPTION

Some of the embodiments will be described in detail, with reference to the following figures, wherein like designations denote like members, wherein:

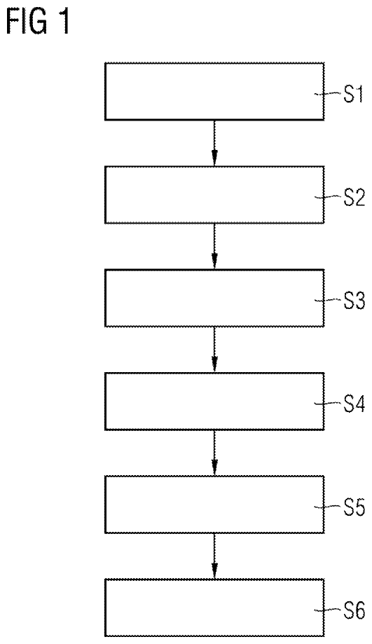

FIG. 1 shows a flowchart for the method according to embodiments of the invention; and

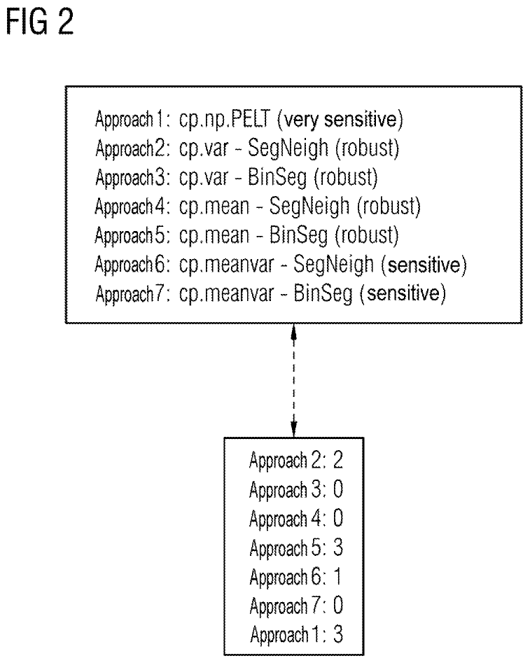

FIG. 2 shows a cardinal statistical label according to an embodiment of the invention.

### DETAILED DESCRIPTION

FIG. 1 schematically shows a flowchart for the method according to embodiments of the invention with the method steps S1 to S6.

Indexing the plurality of time series S1 to S3.

The plurality of time series are indexed, the time series being able to be stored in a time series database and being provided for indexing in a first step S1. As an alternative to the database, a different storage unit may be used, such as a cloud.

To this end, time series sections are initially generated from the time series S2, by applying the combination of statistical approaches or the machine learning model to the provided time series. The generated time series sections are indexed S3. Next, the key value indices are assigned S4.

The respective key value index is in the form of a numerical vector that denotes the respective time series section as a key and has the at least one position or one place in the respective time series as a value.

Illustrative key value indices are listed below.

### Example 1

0110101: 22, 34, 66

The key is 0110101 and accordingly a binary code. For each statistical approach in the combination of statistical approaches, a bit is displayed indicating whether the associated statistical approach has (1) or has not (0) detected an event.

In the 0110101 example, 7 statistical approaches form a combination of statistical approaches, 4 of the 7 approaches detecting an event and 3 of the 7 approaches not detecting an event. The majority of the statistical approaches therefore detect an event.

The value is 22, 34, 66 and is the position or place of the respective time series section in the time series.

### Example 2

1001110: 127, 883, 90

The key is 1001110 and accordingly a binary code. In the 1001110 example, 7 statistical approaches form a combination of statistical approaches, 4 of the 7 approaches detecting an event and 3 of the 7 approaches not detecting an event. The majority of the statistical approaches therefore detect an event.

The value is 127, 883, 90 and is the position or place of the respective time series section in the time series.

Searching the indexed time series sections for the input pattern S5, S6.

The indexing allows an efficient search for the input pattern to be performed on the indexed time series sections.

According to one embodiment, a range search (preliminary search) may initially be performed in order to generate a first set of search results. In other words, the range search looks for the input pattern in the form of the numerical vector, for the statistical label.

On the basis of that, a second search may be performed on this first set of search results by a more accurate or more specific method, DTW, in order to generate a second set of search results. In other words, the second search further limits the search results from the first search. The second search may also be referred to as a point search.

According to one embodiment of the invention, the index key in the form of the statistical label may be extended to form a cardinal statistical label, which is shown in FIG. 2. The cardinal statistical label records how often the respective statistical approach in the combination of statistical approaches has detected changes in the relevant period.

The cardinal statistical label is referred to as the second key and is recorded in the key value index. The preliminary search may be divided into two steps in this case, as follows:

In a first step, the statistical label is initially sought (key 1, binary statistical label). Then, in a second step, the cardinal statistical label is sought (key 2, cardinal statistical label). In other words, limiting is carried out in the second step, the limiting being carried out by way of a metric for the cardinal statistical label.

According to one embodiment, all results for which the distance from the cardinal statistical label predefined by the search does not exceed a certain magnitude are returned.

### Example

Cardinal statistical label 1 (abbreviated to KSA 1)=2 1 2 0 0 2
Cardinal statistical label 2 (abbreviated to KSA 2)=1 1 3 0 0 1

### Distance (KSL1, KSL2)=|2−1|+|1−1|+|2−3|+|0−0|+|0−0|+|2−1|=3

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A computer-implemented method for recognizing an input pattern in at least one time series of a plurality of time series; wherein the input pattern is a time series section of a specific length, the method comprising:
a. providing the plurality of time series, wherein:
each time series of the plurality of time series comprises a chronologically ordered sequence of input data;
b. generating a plurality of associated time series sections of a specific length on a basis of the plurality of time series by a combination of statistical approaches or a machine learning model, wherein:
the machine learning model was trained on at least some of the plurality of time series using the combination of statistical approaches;
c. indexing each time series section of the plurality of time series sections;
d. assigning each time series section to an applicable key value index, wherein:
the respective key value index comprises a numerical vector that denotes the respective time series section as a key and the at least one position or the at least one place in the respective time series as a value;
e. recognizing the input pattern in at least one time series of the plurality of time series by identifying at least one time series section that matches or is similar to the input pattern by a similarity search approach on a basis of the plurality of indexed time series sections; and
f. providing the at least one identified time series section as an output pattern that matches or is similar to the input pattern if a match or similarity is detected.

2. The computer-implemented method as claimed in claim 1, wherein the input pattern is input by a user via an input interface, by a manual input or a voice input.

3. The computer-implemented method as claimed in claim 1, wherein the plurality of time series and/or the plurality of associated time series sections are stored in a database or cloud.

4. The computer-implemented method as claimed in claim 1, wherein the input data are acquired by way of a data acquisition unit, the data acquisition unit being a sensor unit, a camera unit, or an image recognition unit.

5. The computer-implemented method as claimed in claim 1, wherein the plurality of time series are provided via one or more interfaces.

6. The computer-implemented method as claimed in claim 1, wherein the indexed time series sections are stored in a database or cloud.

7. The computer-implemented method as claimed in claim 1, wherein the numerical vector is a cardinal statistical label.

8. The computer-implemented method as claimed in claim 1, wherein the similarity search approach is a search method for searching for patterns based on similarity, or on dynamic time normalization (dynamic time warp, DTW).

9. The computer-implemented method as claimed in claim 1, further comprising performing at least one measure on a basis of the at least one identified time series section as output pattern, wherein the at least one measure is a measure selected from the group consisting of:
displaying the output pattern on a display unit, the output pattern being displayed to a user;
the user analyzing or processing the output pattern;
selecting or filtering the output pattern from a plurality of the identified time series sections, taking account of the preceding analysis or processing by the user;
transmitting the at least one output pattern to a computing unit for further analysis, further processing, further selection of further filtering by way of the computing unit;
storing the output pattern in a storage unit, the storage unit being a volatile or non-volatile storage medium;
analyzing or processing the output pattern;
selecting or filtering the output pattern from a plurality of the identified time series sections;
initiating a countermeasure on the basis of the analysis, the processing, the selection or the filtering; and
providing an error message if no match or no similarity is detected.

10. A technical system for performing the computer-implemented method as claimed in claim 1.

11. A computer program product, comprising a computer readable hardware storage device having computer readable program code stored therein, said program code executable by a processor of a computer system to implement a method as claimed in claim 1 when the computer program is executed on a program-controlled device.
